(19) United States
(12) Patent Application Publication
(10) Pub. No.: US 2011/0185748 A1
(43) Pub. Date: Aug. 4, 2011

(54) NATURAL GAS SUPPLY METHOD AND APPARATUS

(76) Inventor: Vincent Fuchs, Bartenheim (FR)

(21) Appl. No.: 12/809,113

(22) PCT Filed: Dec. 19, 2008
(86) PCT No.: PCT/IB2008/003753

§ 371 Date: Sep. 14, 2010

(30) Foreign Application Priority Data
Dec. 21, 2007 (EP) EP07352008

(51) Int. Cl. F17C 9/02; F17C 13/08; F17C 13/02

(52) U.S. Cl. 62/50.2; 62/53.2; 62/50.6

(57) ABSTRACT

Liquefied natural gas is stored, for example, on board ship, in a battery 2 of storage tanks 4, 6, 8 and 10. Submerged pumps 16 are used to transfer the LNG to secondary storage vessel 22. The pressure of the LNG is raised and it is transferred from the secondary vessel 22 to a forced vaporiser 36, in which it is vaporised. The outlet pressure of each submerged pump 16 may be relatively low and the apparatus may be operated either intermittently or continuously.

This invention relates to a method of and apparatus for supplying natural gas fuel for the purpose of heating or power generation. The method and apparatus according to the invention are particularly suitable for use on board a ship adapted for the storage and transportation of liquefied natural gas (LNG) for the purpose of utilising a part of the LNG to fuel the ship's engines or other propulsion system.

EP1291576A relates to apparatus for supplying natural gas fuel (the principal component of which is methane) to heat the boilers of an ocean-going tanker for the transport of LNG. The apparatus comprises a compressor having an inlet communicating with the ullage space of at least one LNG storage tank and an outlet communicating with a conduit leading from the compressor to fuel burners associated with the boilers, and a forced LNG vaporiser having an inlet communicating with a liquid storage region of the said tank and an outlet communicating with the same or a different conduit leading to fuel burners associated with the conduit.

It is also known to employ so-formed vaporised natural gas directly in the propulsion of the ocean-going tanker or ship. In particular, three such kinds of propulsion are known commercially. First, there are medium speed, dual-fuel engines with electric propulsion. This system has become well established commercially and competes with the previously used system of boilers with steam turbine propulsion. Second, there are low speed, heavy fuel oil burning diesel engines combined with a reliquefaction unit for recovering naturally vaporising natural gas. Third, a gas turbine propulsion system is being evaluated. These propulsion systems have it in common that the naturally evaporated natural gas is either consumed for the propulsion or is reliquefied, being vented or thermally oxidized only in emergency case.

Some of the fuel supplied to the medium speed, dual fuel engines is taken from the stored natural gas. Part of the natural gas fuel is made up of gas which evaporates naturally in the storage tanks of the ship. The rest of the natural gas fuel is forcibly vaporised. Because natural gas is now supplied directly to the ship's engines there is no need for a natural gas reliquefaction unit or for gas venting or burning in thermal oxidizer provided the amount of the naturally evaporated natural gas is equal or smaller than the amount needed by engines for the selected ship cruising speed.

WO-A-2006/077094 relates to an improved method and apparatus for supplying natural gas to a ship's engines or other propulsion unit. A primary stream of boiled-off natural gas is taken from the ullage space of a liquefied natural gas vessel. The primary stream is mixed with a secondary stream which is formed by forcibly but partially vaporising a stream of LNG taken from the vessel, and disengaging the unvaporised natural gas from the vaporised stream. As is explained in WO-A-2006/077094 this method enables the composition of the natural gas formed by mixing the primary and secondary streams to be controlled so as to meet the specification for engines or other propulsion unit.

A further alternative low speed direct propulsion means of propulsion, known as the slow speed diesel engine modified for high pressure gas injection, is now available commercially for the propulsion of ocean-going carriers for the storage and transport of LNG. The engine is of a two stroke diesel kind. This engine has a high efficiency, especially with a directly coupled propeller. On LNG carriers, the desired power for propulsion can be generated by a single engine with a single propeller combined with a power “take home” system, or a double engine installation with direct drive to the two propellers. One particular advantage of the double slow speed diesel engine with high pressure gas injection systems is that if the natural gas fuel supply fails, it is possible to operate at least one of the engines solely with heavy fuel oil, although this is not wholly desirable for environmental reasons. The slow speed diesel engine with high pressure gas injection employs an elevated pressure supply of natural gas. In order to achieve high operating efficiencies the natural gas is typically compressed to a pressure in the range of 200-300 bar. At lower loads, the pressure needed decreases linearly to 30% engine load, which typically requires a pressure of 150 bar. It has been proposed to form the elevated gas supply by mixing compressed boil off gas with forcibly vaporised gas and further compressing the mixture to the required pressure for the respective propulsion system.

There are other uses to which the LNG can be put on board an ocean-going carrier for the storage and transportation of LNG. For example WO-A-20051068847 discloses that some of the LNG can be used to remove heat of compression from boiled-off natural gas between the stages of a plural stage compressor and upstream of its initial stage.

The use of some of the stored LNG to fuel the ship's engines (or other propulsion units such as gas turbines) places particular requirements on the equipment for supplying the natural gas from the ship's storage tanks that conventionally arrangements are not best suited to meet, particularly when the tanks contain only a relatively small amount of LNG during ballast voyage. Specific problems that are solved by the method and apparatus according to the invention are described below.

According to the invention there is provided apparatus for supplying natural gas at elevated pressure, the apparatus including at least one main storage vessel for LNG, a submerged pump in the said main storage vessel, the submerged pump being able to be placed in communication with a supply pipeline in which is located a forced vaporised of the LNG, wherein there is also located in the natural gas supply pipeline at least one secondary vessel for holding the LNG able to be placed in communication with the forced vaporiser, and wherein the secondary vessel has associated therewith means for transferring the LNG under pressure from the secondary holding vessel to the forced vaporiser. Preferred features of the apparatus according to the invention are set out in claims 2 to 10 below.

The invention also provides a method for supplying natural gas at elevated pressure, comprising storing LNG in at least one main storage vessel, transferring LNG by means of submerged pump from the said main storage vessel along a pipeline to at least one secondary vessel for holding the LNG, raising the pressure of the LNG and transferring the raised pressure LNG along the pipeline from the secondary holding vessel to the forced vaporiser, and vaporising the LNG in the forced vaporiser. Preferred features of the method according to the invention are set out in claims 12 to 17 below.

The method and apparatus according to the invention offer a number of advantages as follows, particularly in the supply of natural gas to a propulsion system on board an ocean-going LNG tanker:
the submerged pump in the or each main storage vessel may be a low pressure pump (e.g. having an outlet pressure in the order of 3-4 bars);
the method and apparatus according to the invention may be operated to supply LNG under pressure from the secondary holding vessel to the forced vaporiser intermittently or continuously depending on the choice of the pressure raising means associated with the secondary vessel;
the or each submerged pump may be operated intermittently and for a reduced period of time in comparison with gas supply requirements;
the or each main storage tank may carry less LNG than is conventional for a ballast voyage;
the method and apparatus according to the invention may be utilized at the end of ballast voyage for LNG storage tank cooling, when the submerged pump does not prime because the LNG level is too low;
the method and apparatus according to the invention may be utilized for removing heat of compression from naturally-vaporised LNG between stages and/or for precooling the naturally vaporised LNG upstream of or in a compressor for the naturally vaporised LNG.

Preferably the or each secondary vessel has an upper liquid level and a lower liquid level sensor, the said sensors being operatively associated with an inlet valve, the arrangement being such that LNG flows into the said secondary vessel is initiated only when the level of LNG therein falls to below that of the lower level sensor and is stopped only when the level of LNG therein rises to that of the upper level sensor.

The natural gas is typically transferred from the forced vaporiser to at least one engine or turbine operable to generate power for propulsion of the ship or carrier. The pressure to which the liquid natural gas in the or each secondary vessel is raised depends on the operating pressure of the said engine or turbine. In some relatively low pressure systems, this pressure may be up to 11 bar. If the or each engine or turbine requires a supply of such relatively low pressure natural gas only intermittently, the LNG may be transferred from the or each secondary vessel to the forced vaporiser by isolating the or each secondary vessel, raising the pressure in the ullage space of the or each secondary vessel, and then placing the or each secondary vessel in communication with the forced vaporiser so as to enable the pressure in the ullage space to effect the transfer. The advantage of this means of transfer is that no further mechanical pump is required. If two or more such systems are employed in parallel, the gas supply can be continuous. The or each secondary vessel is typically depressurised prior to being recharged with LNG by the low pressure submerged pump.

If a continuous supply of LNG to the forced vaporiser is required, or the elimination of any pressurized gas losses by depressurization of the secondary vessel, at least one secondary pump may be provided in the pipeline intermediate the said secondary vessel and the forced vaporiser. The secondary pump or pumps may be used to create any elevated pressure up to, say, 300 bar. A cryogenic liquid reciprocating pump having a single or a plurality of cylinders can be used to create the high pressures that are typically needed if the vaporised natural gas is to be supplied to an slow speed diesel engine with high pressure gas injection or to a gas turbine. An advantage of such an arrangement is that it obviates the need for a high pressure gas compressor to raise the pressure of the vaporised natural gas to an injection pressure for use in an slow speed diesel engine with high pressure gas injection or in certain kinds of gas turbine.

Preferably, in apparatus according to the invention for supplying with natural gas fuel an slow speed diesel engine with high pressure gas injection or a gas turbine, the entire flow of natural gas fuel flows through the said pipeline, and all the naturally boiled-off LNG is reliquefied. The reliquefied natural gas may be sent to the or each secondary vessel, any excess being returned from the secondary vessel to the main storage vessel or vessels. Alternatively the reliquefied natural gas can be sent directly to the main storage vessel. This arrangement with the reliquefaction of the naturally boiled-off LNG will eliminate any possible waste of the gas by venting or burning in a thermal oxidiser in the event that the amount of the naturally evaporated natural gas is higher than the amount needed by engines for the selected ship cruising speed or engine load.

If the apparatus according to the invention includes a compressor for compressing naturally-vaporised LNG, a part of the LNG from the or each secondary vessel may be supplied for the purposes of removing heat of compression from the naturally-vaporised LNG between stages and/or for precooling the naturally vaporised LNG. Heat exchangers can be used for this purpose, but precooling is preferably effected by mixing the LNG from the or each secondary vessel with the naturally-vaporised LNG.

The forcibly vaporised natural gas is typically raised in temperature either directly in the forced vaporizer, or downstream of the forced vaporiser by passage through a heat exchanger. The forced vaporizer and the heat exchanger may be heated by steam or any suitable heating medium like hot water from the engine cooling system.

The method and apparatus according to the present invention will now be described by way of example with reference to the accompanying drawings, in which:

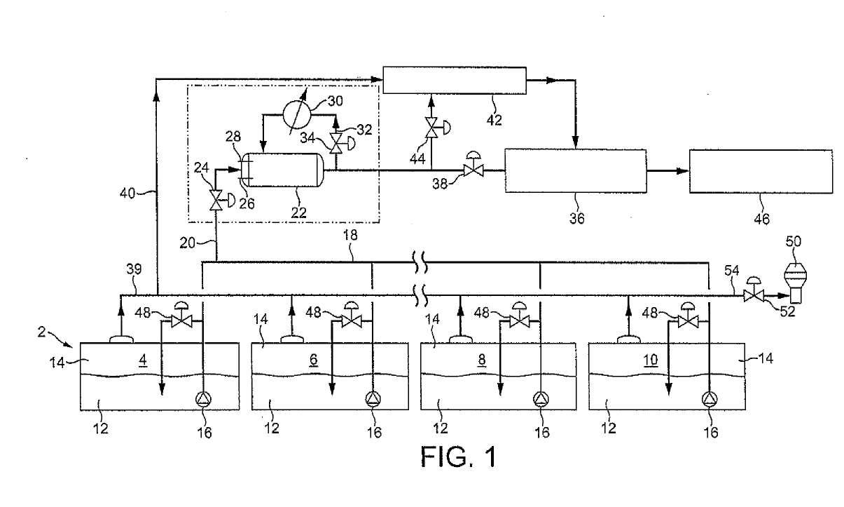

FIG. 1 is a schematic flow diagram of a first apparatus for the supply of natural gas from a battery of LNG storage vessels;

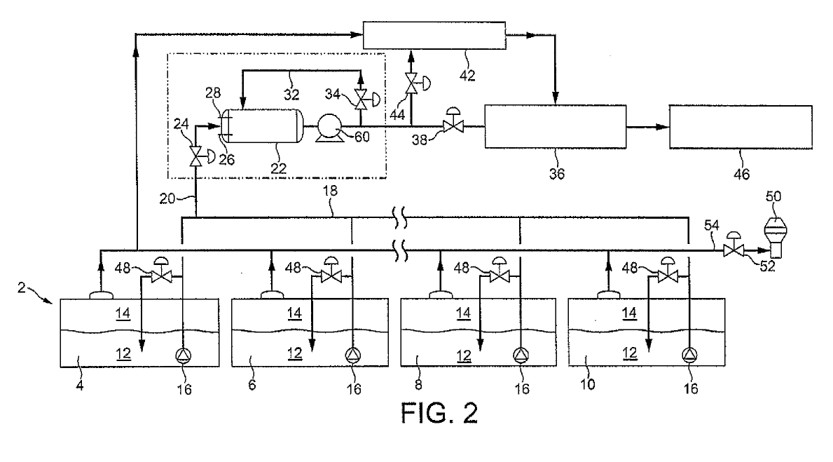

FIG. 2 is a schematic flow diagram of a second apparatus for the supply of natural gas from a battery of LNG storage vessels; and

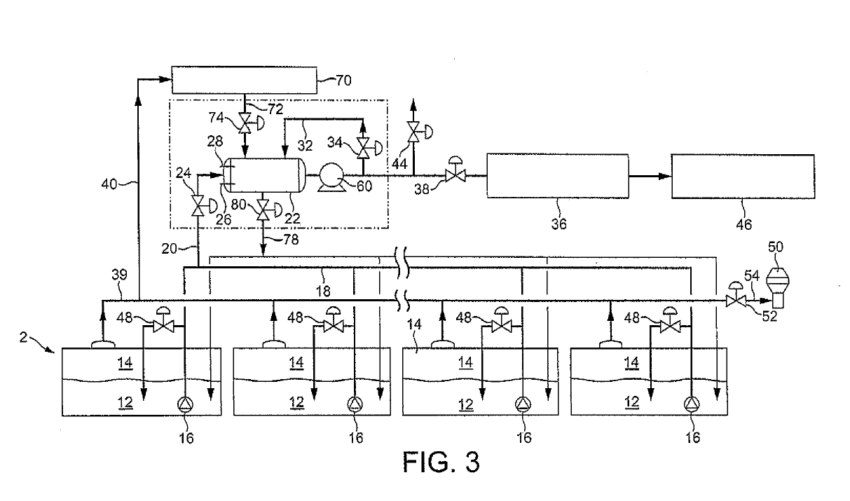

FIG. 3 is a schematic flow diagram of a third apparatus for the supply of natural gas from a battery of LNG storage vessels.

The drawings are not to scale.

Like parts in the drawings are indicated by the same reference numbers.

Referring to FIG. 1 of the drawings, there is shown a battery 2 of main LNG storage tanks or vessels. The main storage tanks or vessels are located on board an ocean-going carrier (not shown). Four essentially identical storage tanks, 4, 6, 8 and 10 are illustrated in FIG. 1. Typically, in practice, the battery 2 can also comprise more than these four storage tanks 4, 6, 8 and 10. Each of the LNG storage tanks 4, 6, 8 and 10 is thermally-insulated so as to keep down the rate at which their contents, LNG, absorbs heat from the surrounding environment. Each of the storage tanks 4, 6, 8 and 10 is shown in FIG. 1 as containing a volume 12 of LNG. There is naturally an ullage space 14 in each of the tanks 4, 6, 8 and 10 above the level of the liquid therein. Since NG boils at a temperature well below ambient, there is a continuous evaporation of the LNG from each volume 12 into the ullage space thereabove.

Each of the tanks 4, 6, 8 and 10 contains a cryogenic pump 16 submerged in the volume of LNG therein. Each pump 16 is operable to pump LNG out of the tank in which it is located to a distribution header 18. The header 18 communicates with an LNG pipeline 20. A secondary thermally-insulated LNG storage vessel or drum 22, typically having a smaller capacity than each of the tanks 4, 6, 8 and 10, is located in the pipeline 20. The drum 22 may be placed in communication with the header 18 by opening a valve 24 located upstream of the drum 22. The drum is thus able to be charged with LNG. In one arrangement, the drum 22 is provided with a lower level sensor 26 and an upper level sensor 28. When the level of the LNG in the drum 22 falls below that of the lower level sensor 26, the pumps 16 may be actuated, the valve 24 opened and LNG supplied to the drum 22. When the level of the LNG in the drum 22 reaches that of the upper level sensor 28, the operation of the pumps 16 may be stopped and the valve 24 closed again.

The drum 22 is operatively associated with a vaporiser or pressure raising coil 30. The vaporiser or pressure raising coil 30 is located in a conduit 32 which extends from a region of the LNG pipeline 20 immediately downstream of the drum 22 to the ullage space of the drum 22. A flow control valve 34 is located in the conduit 32. The vaporizer or pressure raising coil 30 may be also arranged independent of the pipeline 20, but directly on the drum 22.

The position of the valve 34 may be controlled by a pressure sensor (not shown) in the ullage space of the drum 22, the arrangement being such that the pressure therein is maintained at a generally constant level by controlled vaporisation of LNG in the vaporiser or pressure raising coil 30. Typically, this pressure is in the range of 5 to 11 bar absolute.

It is under the pressure in the ullage space of the drum 22 that a batch of LNG can be passed from the drum 22 along the pipeline 20 to forced LNG vaporisation and heating units 36. A valve 38 is located in the pipeline 20 and when closed isolates the LNG vaporisation and heating units 36 from the drum 22. When, however, the valve 38 is open LNG flows from the drum 22 under the pressure of vaporised natural gas in its ullage space to the forced LNG vaporisation and heating units 36.

In one arrangement (not shown) the forced (or forcing) vaporiser is of a kind which employs steam heating, or hot water, or hot water-glycol mixture heating to raise the temperature of the fluid flowing through a vaporisation chamber thereby to vaporise the LNG supplied from the drum 22. A nest of heat exchange tubes may be employed to effect the heat transfer from the steam, hot water, or hot water-glycol to the LNG. The forced vaporiser is also typically provided with a by-pass line which extends from immediately upstream of the vaporiser to a static mixing chamber immediately downstream of the vaporiser. The by-pass line can be used to control the temperature of the gas downstream of the vaporiser. This gas is typically mixed with naturally boiled-off gas from the main storage tanks 4, 6, 8 and 10. The boiled-off gas flows out of the tanks into a second header 39 which communicates with a second natural gas pipeline 40. A plural stage compressor 42 is located in the pipeline 40. The compressor 42 is operated to raise the pressure of the boiled-off natural gas to approximately that maintained in the ullage space of the drum 22. The compressed boiled-off natural gas is mixed with the forcibly vaporised natural gas and the mixture is typically raised to approximately ambient temperature, preferably by indirect heat exchange in a heat exchanger with steam or other heating medium, e.g. hot water, or hot water-glycol mixture. In general, the drum 22 has a relatively low capacity and most of the natural gas for propulsion purposes is provided from the compressor 42. Moreover, if the compressor 42 is of a plural stage kind, precooling and interstage cooling of the compressed natural gas is preferably provided by a flow of LNG from the drum 22. This LNG flows through a valve 44 to a heat exchanger or heat exchangers (not shown) in which it removes heat of compression from the boiled-off natural gas between the or each pair of successive compression stages in the compressor 42. The resulting vaporised natural gas can be mixed with the boiled-off gas. Moreover, some of the LNG from the drum 22 can be premixed with the boiled-off gas upstream of the compressor 42 so as to provide precooling of the boiled-off gas.

The heated natural gas from the forced LNG vaporisation and heating units 36 is supplied along the pipeline 20 to one or more engines or gas turbines of a propulsion means 46 for the ocean-going carrier. The apparatus shown in FIG. 1 is able to provide a base load of boiled-off natural gas from the tanks 4, 6, 8 and 10 to the propulsion means 46. The rate at which this base load is supplied depends on the amount of LNG that the battery 2 of tanks is carrying. When these tanks are fully laden this base load is greater than when the tanks are carrying LNG during ballast voyage, in which instance the tanks may be charged with LNG typically to only 3% or less of their maximum capacity. The forced vaporiser may be employed periodically to enhance the rate of natural gas supply to the engines of the propulsion means 46. This ability is advantageous when operating a dual fuel engine at medium pressure (say in the range of 5 to 10 bar). It is, however, also possible to employ a drum 22 of sufficient capacity that the need to maintain quantities of LNG in the tanks 4, 6, 8 and 10 as ballast once they have discharged their main load of LNG is minimised. This minimised amount of ballast consists of the unpumpable residue of LNG that remains after the ship unloading. In such a case the compressor 42 is periodically shut down. With nearly empty battery 2 of storage tanks, the compressor 42 might be operated for, say, 0.5 days every 2.5 days. On start up after a shut down period, the discharge pressure of the compressor 42 would be too low for a propulsion system 46 comprising DFDE engines without use of the LNG from the drum 22 in order to lower the temperature of the BOG upstream of the compressor 42.

One of the advantages of the apparatus shown in FIG. 1 is that the submerged pumps 16 need only be of a relatively low pressure kind. Such pumps are usually already installed in the tanks for spraying and stripping purposes and therefore no additional high pressure fuel submerged pumps need to be installed in the tanks. Typically, the pumps 16 supply the LNG to the drum 22 under a pressure of 3-4 barFurther the pumps 16, because they usually have a much higher flow capacity than required for propulsion of the ship, need be operated only intermittently to keep the drum 22 charged with LNG. As a result, the capital and operating costs of the natural gas supply system is able to be kept down. In addition, risk of mechanical wear of any of the pumps 16 is reduced due to the limited running time. This is a significant advantage because the pumps 16 can be repaired only in dry dock.

Another feature of the apparatus shown in FIG. 1 are that the submerged pumps 16 may be used to pass back some of the LNG to the tanks 4, 6, 8 and 10 through valves 48. This measure helps to keep down temperature stratification in the tanks 4, 6, 8 and 10. Another function of the pumps 16 is to keep these tanks cold during ballast voyage by spraying. A further feature of the apparatus shown in FIG. 1 is that in the event of excess natural boil off of the LNG, excess vapour can be vented in emergency to a vent mast 50 or to a thermal oxidiser unit (not shown) through a valve 52 located in a conduit 54 communicating with the second header 39.

Referring now to FIG. 2 of the drawings, there is shown therein an alternative apparatus to that shown in FIG. 1 for providing a medium pressure (up to 10 bar g) supply of forcibly vaporised LNG to the engines (or turbines) of a propulsion system 46. One drawback to the apparatus shown in FIG. 1 is that when the level of the liquid in the drum 22 falls to beneath that of the lower level sensor 26 it is generally desirable to close the valve 38 (in order to isolate the forced vaporisation and heating units 36 from the drum 22), to release the pressure in the drum and to recharge the drum 22 until the volume of LNG has been raised to the level of the upper level sensor 28. In the apparatus shown in FIG. 2, a mechanical cryogenic pump 60 is substituted for the pressure building vaporiser or coil 30. The pump 60 can be of any kind suitable for pumping and pressurizing cryogenic liquids, e.g. centrifugal, reciprocating or any other positive displacement kind. This pump 60 is operable to supply LNG continuously to the forced vaporisation and heating units 36 of the apparatus shown in FIG. 2 and for cooling of the boiled-off gas upstream and between stages of the compressor 42. The conduit 32 and flow control valve 34 are retained with the inlet to the conduit 32 being located downstream of the pump 60, to maintain the minimum pump flow in case of low engine load and thus low natural gas consumption. The pump 60 can be operated at a constant rate with any excess LNG being returned to the drum 22 via the conduit 32. In other respects, the configuration and operation of the apparatus shown in FIG. 2 is the same as that shown in FIG. 1.

The apparatus shown in FIG. 3 is intended to supply natural gas to the propulsion system 46 at a high pressure, typically well above 11 bar, and up to supercritical pressures in the range 200 to 300 bar. At supercritical pressures there is no change of phase when the natural gas passes through the forced vaporiser forming part of the heating and vaporisation units. In the context of this specification, the term ‘vaporisation’ embraces the heating of a supercritical fluid from a first temperature at which were it to be returned to the secondary vessel or drum 22 at that first temperature and at the operating pressure of the drum it would be a liquid to a second temperature higher than the first temperature such that were the natural gas to be returned to the secondary vessel or drum at that second temperature and at the operating temperature of the secondary vessel or drum 22 it would be a gas. The pump 60 is typically a single or plural cylinders cryogenic liquid reciprocating pump able to raise the pressure of the natural gas to a desired supercritical pressure. In most other respects the configuration and operation of the apparatus shown in FIG. 3 is the same as that shown in FIG. 2. Another important difference is, however, in operation of the apparatus shown in FIG. 3, the gas naturally boiled-off from the battery 2 of main storage tanks is not merely compressed but is liquefied in a liquefier 70 which is substituted for the compressor 42 (but which still includes a compressor).

The liquefier 70 may be of the kind disclosed in ERA-1132698. It typically employs a two stage compressor, and there may be therefore a need for interstage cooling of that compressor. Nonetheless, it is still preferred to use LNG from the drum to precool the boiled-off gas upstream of the compressor 42, preferably by mixing it with the boiled-off gas. Alternatively, some of the liquid from the liquefier 70 may be used for this purpose. Accordingly, the valve 44 and the pipe in which it is located may be omitted from the apparatus shown in FIG. 3. There is a pipe 72 extending from the liquefier 70 to the secondary vessel or drum 22 and a flow control valve 74 located in the pipe 72. As a result, all the liquefied boil off gas is returned to the drum 22. A consequence of this return of liquid to the drum 22 is that the total rate of liquid flow into the drum 22 is typically greater than the total rate at which liquid is withdrawn from the drum 22. Excess liquid is therefore returned from the drum 22 to the battery 2 of main storage tanks or vessels via a further pipe 78 the further pipe 78 having disposed therein a flow control valve 80 for regulating the rate of return of the LNG to the battery 2 of tanks and thus the liquid level in the drum 22. Alternatively the reliquefied natural gas can be sent directly from the liquefier 70 to the battery 2 of main storage tanks.

Further, in normal operation of the apparatus shown in FIG. 3, the naturally boiled-off gas evolving from the battery 2 of main storage tanks is essentially all liquefied by the liquefier 70. There is therefore no line in the apparatus shown in FIG. 3 corresponding to that in FIG. 2 which conveys the compressed boil off gas to the vaporisation and heating unit 36 for mixing with the forcibly vaporised LNG.

The apparatus shown in FIG. 3 is able to be operated to supply continuously high pressure gas for injection into a slow speed diesel engine or engines with high pressure gas injection forming part of the propulsion unit 46 of the ocean-going carrier.

Instead of having a single drum 22, each apparatus shown in the drawings may include a plurality of such drums. In the apparatus shown in FIGS. 2 and 3, if a plurality of drums in parallel are substituted for the single drum 22 shown therein, each such added drum has its own dedicated pump 60.

Another advantage of the apparatus shown in FIG. 2 or FIG. 3 is that the drum 22 and the pump 60 are readily accessible for maintenance. Further, the pump 60 can readily be primed for use.

The apparatus shown in FIG. 3 is advantageous, when the amount of the naturally evaporated natural gas is higher than the amount needed by engines for the selected ship cruising speed or engine load. It avoids any possible waste of the gas by venting or burning in the thermal oxidiser. Such waste may be significant when cruising at typical normal ship speed instead of design speed (maximum continuous speed).

The apparatus shown in FIG. 3 is also advantageous in that it avoids by means of liquid pumping the use of any very high pressure gas compression machinery with high power consumption.

1. Apparatus for supplying natural gas at elevated pressure, the apparatus comprising at least one main storage vessel for LNG, a submerged pump in the main storage vessel, the submerged pump being able to be placed in communication with a supply pipeline in which is located a forced vaporised of the LNG, wherein there is also located in the natural gas supply pipeline at least one secondary vessel for holding the LNG able to be placed in communication with the forced vaporiser, and wherein the at least one secondary vessel has associated therewith means for transferring the LNG under pressure from the at least one holding vessel to the forced vaporiser.

2. The apparatus according to claim 1, further comprising a compressor for compressing naturally-vaporised LNG from the said main storage vessel, and means for precooling the naturally-vaporised LNG upstream of the compressor with LNG from the at least one secondary vessel.

3. The apparatus according to claim 2, further comprising a mixer for premixing LNG from the or each secondary vessel with the naturally-vaporised LNG.

4. The apparatus according to claim 2, wherein the compressor is a plural stage compressor and there is a heat exchanger for removing heat of compression from the naturally-vaporised LNG intermediate a pair of its stages, the heat exchanger having cooling passages able to be placed in communication with the or each secondary vessel.

5. The apparatus according to claim 1, wherein the at least one secondary vessel has an upper liquid level and a lower liquid level sensor, the said sensors being operatively associated with an inlet valve, the arrangement being such that LNG flow into the said secondary vessel is initiated only when the level of LNG therein falls to below that of the lower level sensor and is stopped only when the level of LNG therein rises to that of the upper level sensor.

6. The apparatus according to claim 1, wherein said means for transforming the LNG under pressure includes a heat exchanger or pressure raising coil associated with the secondary holding vessel.

7. The apparatus according to claim 1, wherein said means for transferring the LNG comprises at least one secondary pump.

8. The apparatus according to claim 7, wherein the at least one secondary pump is a reciprocating pump having at least one cylinder.

9. The apparatus according to claim 7, comprising a plurality of the secondary vessels in parallel, each secondary vessel having a secondary pump.

10. The apparatus according to claim 7, further comprising a liquefier for liquefying naturally-vaporised LNG from the main storage vessel, the liquefier having an outlet for LNG able to be placed in communication with the at least one secondary vessel or with the main storage vessel.

11. The apparatus according to claim 1, wherein the apparatus is arranged to supply natural gas to a propulsion system on board an ocean-going LNG tanker.

12. A method for supplying natural gas at elevated pressure, comprising storing LNG in at least one main storage vessel, transferring LNG by means of submerged pump from the main storage vessel along a pipeline to at least one secondary vessel for holding the LNG, raising a pressure of the LNG and transferring the raised pressure LNG along the pipeline from the at least one secondary vessel to the forced vaporiser, and vaporising the LNG in the forced vaporiser.

13. The method according to claim 12, wherein the LNG is supplied continuously from the at least one secondary vessel to the forced vaporiser.

14. The method according to claim 12, wherein the LNG is supplied intermittently from the at least one secondary vessel to the forced vaporiser.

15. The method according to claim 12, wherein the LNG is transferred from the at least one secondary vessel to the forced vaporiser under the pressure of vapour in the ullage space of the at least one secondary vessel.

16. The method according to claim 15, wherein the pressure of said vapour is up to 11 bar absolute.

17. The method according to claim 13, wherein the LNG is transferred from the at least one secondary vessel to the forced vaporiser by at least one secondary pump, wherein the at least one secondary pump raises the pressure of the LNG to a pressure up to 300 bar.

18. (canceled)

19. The method according to claim 13, further comprising liquefying naturally-vaporising LNG from the main storage vessel and passing the so-formed liquid to the secondary vessel or returning the so-formed liquid to the main storage vessel.

20. The method according to claim 13, wherein the vaporised LNG is supplied from the forced vaporiser to a propulsion system of an ocean-going LNG tanker.
